(19) United States
(12) Patent Application Publication
(10) Pub. No.: US 2015/0076174 A1
(43) Pub. Date: Mar. 19, 2015

(54) DISPENSING DEVICE FOR FLUIDS FROM A FLUID CONTAINER

(71) Applicant: AERO PUMP GMBH, Hochheim/Main (DE)

(72) Inventor: Andreas MERSMANN, Frankfurt (DE)

(73) Assignee: AERO PUMP GMBH, Hochheim/Main (DE)

(21) Appl. No.: 14/490,085

(22) Filed: Sep. 18, 2014

(30) Foreign Application Priority Data
Sep. 19, 2013 (DE) 102013218802.1

(51) Int. Cl. B05B 11/00; B67B 1/00; B65D 88/54

(52) U.S. Cl. CPC B05B 11/0027
USPC 222/153.13; 222/384; 222/321.2; 222/321.6

(57) ABSTRACT

Dispensing device and method for dispensing fluids from a fluid container. The dispensing device includes an attachment section, a first blocking section, a second blocking section, and an actuating section. A dispensing of the fluid results from actuation of the actuating section and the actuation of the actuating section is blockable by a rotation of at least one of the first blocking section and the second blocking section with respect to the attachment section.

### CROSS-REFERENCE TO RELATED APPLICATIONS

The present application claims priority under 35 U.S.C. §119(a) of German Patent Application No. 10 2013 218 802.1 filed Sep. 19, 2013, the disclosure of which is expressly incorporated by reference herein in its entirety.

### BACKGROUND OF THE INVENTION

1. Field of the Invention

Embodiments of the invention relate to a dispensing device for fluids from a fluid container, comprising an attachment section, a first blocking section and an actuating section. The dispensing of fluid occurs by actuation of the actuating section, and actuation of the actuating section can be blocked by a rotation of the first blocking section with respect to the attachment section.

2. Discussion of Background Information

Dispensing devices of this type serve to dispense fluids, e.g., medical active substance solutions into the nose, mouth or eyes or to dispense cosmetic products. An attachment of the dispensing device to the fluid container occurs with the aid of the attachment section.

Typically, a predetermined amount of the fluid is thereby conducted out of the fluid container and transported to an outlet opening by a manual actuation of the actuating section.

A dispensing device of the type named at the outset is known, e.g., from DE 602 11 855 T2. The dispensing device disclosed therein comprises an attachment section, an actuation section and a locking device. With the aid of the locking device, the actuation of the actuating section can be prevented by a rotation of the actuating section with respect to the attachment section.

Although dispensing devices of this type allow an unwanted actuation of the dispensing device during transport and, in particular, before arriving at the end consumer to be avoided in principle, an unwanted unlocking of the dispensing device is still possible, as only a locked setting and an unlocked setting of the locking device are provided.

An unlocking is typically achieved by a simultaneous actuation and turning of the actuating section. This has the added disadvantage that, in some cases, unwanted fluid can already be dispensed during the unlocking of the dispensing device.

Furthermore, the unlocking operation of the known dispensing devices is relatively simple, so that the locking device can also be easily overcome by a small child by means of experimentation. In this case, there is a poisoning hazard for the small child, particularly if the fluid container contains a drug.

### SUMMARY OF THE EMBODIMENTS

Accordingly, embodiments of the invention are directed to a dispensing device for fluids from a fluid container which can be reliably blocked.

According to the embodiments, the dispensing device of the type named at the outset includes at least two blocking sections. Actuation of the dispensing device can also be blocked by a rotation of the second blocking section with respect to the attachment section.

An actuation of the dispensing device can thus now also be blocked by both a rotation of the first blocking section with respect to the attachment section and also by a rotation of the second blocking section with respect to the attachment section. Here, it is already sufficient for a blocking of the dispensing device that either the first blocking section or the second blocking section is rotated with respect to the attachment section. For the locking or unlocking of the dispensing device, it is thereby no longer necessary to actuate the actuating section at the same time. In this way, an unwanted dispensing of fluid during the locking or unlocking is avoided. Furthermore, there also results a dispensing device with an effective child safety device, as both the first blocking section and also the second blocking section must be located in a proper rotational position with respect to the attachment section in order to enable an actuation of the dispensing device. Thus, arranging a plurality of blocked relative rotational positions of a first blocking section or a second blocking section with respect to the attachment section can be achieved without a problem. Preferably, both the first blocking section and also the second blocking section respectively allow an actuation of the dispensing device in only one rotational position relative to the attachment section. The dispensing device can also comprise more than two, e.g., three or four, blocking sections, if a particularly high safety of the dispensing device is desired.

In a preferred embodiment, the first blocking section is non-rotatably connected to the actuating section. The first blocking section can thus, for example, be arranged in one piece with the actuating section in a common component. Alternatively, the first blocking section and the actuating section can also be arranged in separate components which can be rotated with respect to one another.

Preferably, the first blocking section has, relative to the attachment section, at least one discrete release position and at least two discrete blocking positions. A discrete position is thereby to be understood as meaning a predefined rotational position into which the first blocking section can be rotated relative to the attachment section and into which the first blocking section then engages for example. Here, it is preferable if a small mechanical resistance must be overcome to switch from one discrete position into another discrete position. In this manner, an unwanted rotation of the first blocking section with respect to the attachment section can be avoided.

It is advantageous if the second blocking section has, relative to the attachment section, at least one discrete release position and at least two discrete blocking positions. It is thereby particularly preferred if both the first blocking section and also the second blocking section have respectively at least nine discrete blocking positions relative to the attachment section. In this case, at least 100 relative setting positions of a first blocking section, second blocking section and attachment section already result in total, wherein the dispensing device is blocked in at least 99 settings. However, an actuation is always possible in at least one discrete release position. An actuation of the dispensing device by pure experimentation without an understanding of the mechanism is then virtually eliminated.

Furthermore, it is advantageous if the second blocking section is arranged between the first blocking section and the attachment section in an actuating direction and is rotatable relative to the first blocking section. A relatively simple structure of the dispensing device hereby results. Preferably, the second blocking section is rotatably connected to, in particular engaged with, the first blocking section. It can hereby be ensured that both the first blocking section and also the second blocking section must be displaced relative to the attachment section in an actuation direction in order to actuate the dispensing device.

It is advantageous if at least one marking is arranged respectively on an outside of the first blocking section, the second blocking section and the attachment section. Preferably, these markings are respectively arranged on a radial outside of the first blocking section, the second blocking section and the attachment section. For example, the markings can be arranged on the three sections indicated such that the dispensing device can only be actuated if all three markings are located one after another in an actuation direction or if all three markings are rotated to the same angle of rotation relative to a common rotational axis. A marking of this type can, for example, be present in the form of a small, radially projecting point. In this way, the dispensing device can also be operated by persons with reduced vision. Alternatively, it is also conceivable that numeral markings are arranged on at least two of the three rotatable sections, and that the dispensing device can only be actuated when a particular combination of numerals is set. In this case, the first blocking section, the second blocking section and the attachment section thus form a combination lock together. An embodiment of this type is conceivable, e.g., for drugs which are particularly dangerous for small children.

It is advantageous if at least one locking device is arranged between the first blocking section, the second blocking section and the attachment section. The at least one locking device can then, e.g., prevent an axial displacement of a first blocking section and a second blocking section in an actuating direction if the first blocking section and the second blocking section are not respectively rotated into the proper relative positions with respect to the attachment section.

Furthermore, it is advantageous if the at least one locking device has at least one recess and at least one projection. The at least one recess and the at least one projection can, preferably in the unactuated state of the dispensing device, be arranged in an axially offset manner in an actuation direction, but can have an identical radial distance from a common rotational axis.

Preferably, the at least one locking device blocks the actuation of the actuating section, unless the at least one recess and the at least one projection are rotated to the same angle of rotation relative to a common rotational axis of a first blocking section, a second blocking section and an attachment section. Here, it is particularly preferred if the at least one recess and the at least one projection respectively are in line with a marking on a radial outside in a radial direction. In this case, it is particularly easy for the end consumer to unlock the dispensing device.

Furthermore, it is advantageous if the projection is arranged on an outside of the dispensing device in an unactuated state of the dispensing device. In this case, the projection can be recognized without a problem by the end consumer. In this way, the projection can at the same time assume the function of one of the markings.

Preferably, the first blocking section and the second blocking section each have at least one recess, and the attachment section has at least one projection. It can thus be achieved, for example, that the dispensing device can only be actuated if both the two recesses and also the one projection are rotated to the same angle of rotation relative to a common rotational axis. The projection can then be slid into the two recesses of the actuating section and blocking section during the actuation of the actuating section.

Furthermore, it is advantageous if the first blocking section and/or the second blocking section include a blocking ring which is rotatably connected to the actuating section. Here, the blocking ring is preferably rotatably engaged with the actuating section. In this way, a stable and compact structure results. However, both blocking sections can also each have one blocking ring. The blocking ring of the first blocking section is then preferably rotatably engaged with the attachment section. In the latter case, both blocking rings can also be rotatably engaged with one another.

It is advantageous if the dispensing device has a guide ring that can be displaced in an actuating direction with respect to the attachment section. The guide ring allows a controlled relative movement of a first blocking section, a second blocking section and an attachment section in an actuating direction. In particular, the guide ring can, during the actuating operation, also absorb the forces acting on the dispensing device. A damaging of the more sensitive inner components of the dispensing device can thus be avoided. Furthermore, the guide ring can also act as a visual cover so that the release positions of the blocking sections cannot be seen from the outside. The latter is primarily advantageous if the blocking sections form a combination lock with the attachment section.

Preferably, the guide ring is arranged in a non-rotatable manner with respect to the attachment section. For this purpose, the guide ring can for example have a gap in a circumferential direction, into which gap a projection of the attachment section engages. At the same time, the guide ring can bear against an axial front-face on the first blocking section and/or on the second blocking section. It is hereby ensured that the guiding section is displaced together with the first blocking section and/or the second blocking section in an actuating direction during an actuating operation, and that a controlled movement of the three different sections relative to one another thus occurs.

Embodiments of the invention are directed to a dispensing device for fluids from a fluid container. The dispensing device includes an attachment section, a first blocking section, a second blocking section, and an actuating section. A dispensing of the fluid results from actuation of the actuating section and the actuation of the actuating section is blockable by a rotation of at least one of the first blocking section and the second blocking section with respect to the attachment section.

According to embodiments, the first blocking section can be non-rotatably connected to the actuating section.

In accordance with other embodiments, with regard to the attachment section, the first blocking section can include at least one discrete release position and at least two discrete blocking positions.

Further, with regard to the attachment section, the second blocking section can have at least one discrete release position and at least two discrete blocking positions.

According to still other embodiments, the second blocking section, with regard to an actuation direction, may be arranged between the first blocking section and the attachment section and can be rotatable relative to the first blocking section.

In accordance with other embodiments, at least one marking each can be arranged respectively on an outside of the first blocking section, the second blocking section and the attachment section.

In further embodiments, the dispensing device can include at least one locking device arranged between the first blocking section, the second blocking section and the attachment section. The at least one locking device can include at least one recess and at least one projection. The locking device can be structured to block actuation of the actuating section, unless the at least one recess and the at least one projection are rotated to the same angle of rotation relative to a common rotational axis of the first blocking section, the second blocking section and the attachment section. Further, in an unactuated state, the at least one projection is arranged on an outside of the dispensing device.

According to other embodiments, the at least one recess may include a first recess in first blocking section and second recess in the second blocking section, and the attachment section may include the at least one projection.

In still other embodiments, at least one of the first blocking section and the second blocking section can include a blocking ring that is rotatably connected to the actuating section.

According to further embodiments, the dispensing device can include a guide ring that can be displaceable, with respect to the attachment section, in an actuating direction. Further, the guide ring can be arranged in a non-rotatable manner with respect to the attachment section.

Embodiments of the invention are directed to a method of actuating the actuating section of the above-discussed dispensing device. The method includes providing indicia on at least the first blocking section, the second blocking section and the attachment section, aligning the indicia on the first blocking section, the second blocking section and the attachment section at a specified angular position around an axis of rotation for at least the first blocking section and the second blocking section, and axially moving a part of the actuating section toward the attachment section.

Embodiments of the invention are directed to a method of actuating a dispensing device that includes a first blocking section, a second blocking section and an attachment section that are rotatable about a common axis, and an actuating section that is axially movable along the common axis when at least the first blocking section and the second blocking section are aligned in an unblocking position. The method includes providing indicia on at least the first blocking section and the second blocking section, aligning the indicia on the first blocking section and the second blocking section at a specified angular position around the common axis at which the first blocking section and the second blocking section are aligned in the unblocking position, and pushing a part of the actuating section toward the attachment section.

In accordance with still yet other embodiments, can include providing further indicia on the attachment section to identify the specified angular position for aligning the indicia. Further, at least the first blocking section and the second blocking section can include polygonal outer peripheries comprising flat surfaces joined at edges. Moreover, the polygonal outer periphery of the first blocking section can have M flat surfaces, where M is a number greater than 2, and the polygonal outer periphery of the second blocking section can have N flat sides, where N is a number greater than 2. In this way, the first blocking section and the second blocking section can be rotatable into (M×N) total positions relative to the further indicia on the attachment section, of which only one of the M×N positions is the unblocking position. The indicia on the first blocking section and the second blocking section include markings on one or more of the flat sides and the further indicia on the attachment section includes a further marking, and the markings and the further marking include at least one of numbers, letters and symbols so that by aligning the markings on the first blocking section and the second blocking section and the further marking on the attachment section according to a predetermined code or pattern identifying the unblocking position is achieved.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a dispensing device for fluids according to the invention in an unactuated position, wherein both the first blocking section and also the second blocking section are located in a release position;

FIG. 2 illustrates the dispensing device according to FIG. 1 along the cross section II-II;

FIG. 3 illustrates the dispensing device according to FIG. 1 along the cross section

FIG. 4 illustrates a longitudinal section of a dispensing device according to the invention, wherein the first blocking section is located in a blocking position and the second blocking section is located in a release position;

FIG. 5 illustrates a cross section of the dispensing device according to FIG. 4 along the cross section V-V;

FIG. 6 illustrates a cross section of the dispensing device according to FIG. 4 along the cross section VI-VI;

FIG. 7 illustrates a further longitudinal section of a dispensing device according to the invention, wherein both the first blocking section and also the second blocking section are located in a blocking position.

FIG. 8 illustrates the dispensing device according to FIG. 7 along the cross section VIII-VIII; and

FIG. 9 illustrates the dispensing device according to FIG. 7 along the cross section IX-IX.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied or formed in practice.

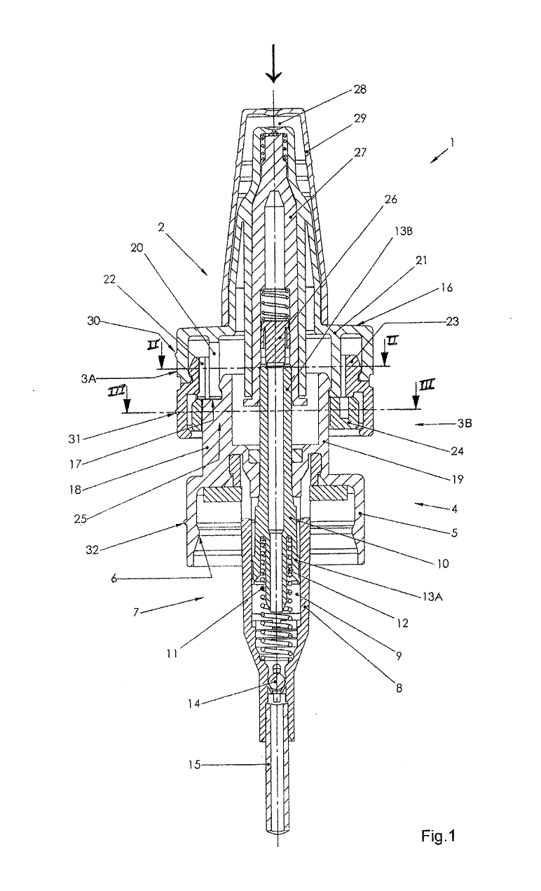

FIGS. 1 through 3 show a first setting of the dispensing device 1. The dispensing device 1 comprises an actuating section 2, a first blocking section 3A, a second blocking section 3B and an attachment section 4.

In the present embodiment, the first blocking section 3A is arranged in one piece with the actuating section 2 in a component. Here, the actuating section 2 is engaged with the attachment section 4, and the actuating section 2 is engaged with the second blocking section 3B.

However, other embodiments are also conceivable, wherein it should merely be ensured that the first blocking section 3A and the second blocking section 3B are each rotatably arranged with respect to the attachment section 4. For example, two or more blocking sections can be embodied or formed as separate components rotatable with respect to the actuating section 2 and the attachment section 4. Three or four blocking sections, for example as rotatable rings, can also be arranged between the actuating section 2 and attachment section 4.

In the present case, the attachment section 4 has a cylindrical fitting section 5. The fitting section 5 has a holding rib 6 directed radially inwards, with which the fitting section 5 can engage on a fluid container. Alternatively, a screwing connection or a comparable attachment mechanism is also conceivable here.

The dispensing device 1 further comprises a pressure chamber 7 with a pressure chamber casing 8. The pressure chamber casing 8 has a cylindrical section which is arranged coaxially along the actuating axis of the dispensing device 1. A piston 10 engages in a pressure chamber interior 9 of the pressure chamber 7.

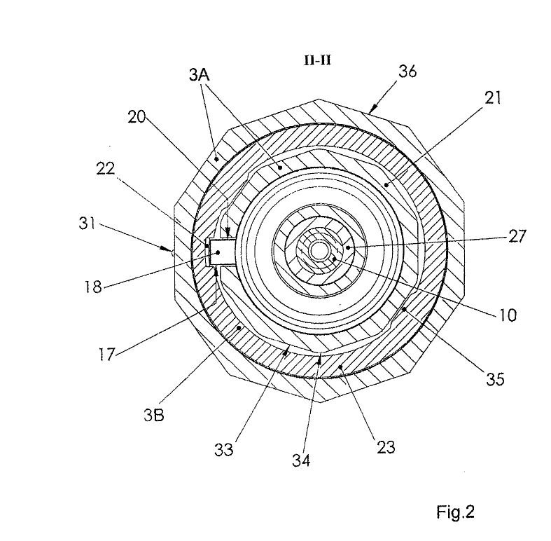

In FIG. 1 (as well as in the subsequent FIGS. 2 through 9), the dispensing device 1 is illustrated in a neutral position; that is, the dispensing device 1 is illustrated in an unactuated position. A spring 11 is arranged between the piston 10 and the pressure chamber casing 8. The spring 11 bears against an axial end of the pressure chamber casing 8. At the opposing axial end thereof, the spring 11 engages in a front-face groove 12 of the piston 10.

The piston 10 is essentially embodied or formed in a tube-shaped manner and has openings in its end sections. The piston 10 engages in the pressure chamber 7 with its first end section 13A. The piston 10 engages in the actuating section 2 with its second end section 13B.

Additionally, the pressure chamber casing 8 comprises a valve 14, which is embodied or formed as a ball valve in the present case. In the opened state, the valve 14 allows the inflow of a fluid from a fluid container (not illustrated). A connector 15 is also inserted into the pressure chamber casing 8, which enables a suctioning of the fluid from the bottom of the fluid container, i.e., without the pressure chamber casing 8 itself having to extend into that location. It is thus ensured that as little as possible of the often expensive fluid is wasted and that a fluid container to be connected to the dispensing device 1 can be emptied as completely as possible.

If the dispensing device is now actuated, a part of the fluid contained in the pressure chamber interior 9 is dispensed. Therefore, an underpressure is produced in the pressure chamber interior 9 during the return to the neutral position. As a result of the underpressure in the pressure chamber interior 9, the valve 14 now opens and new fluid is suctioned out of the fluid container into the pressure chamber interior 9.

The actuating section 2 has an actuating projection 16 in the form of a circumferential step. For the actuation of the dispensing device 1, the consumer now applies a force to the actuating projection 16 in the actuating direction. The actuating direction is indicated in FIG. 1 by an arrow running along the central axis.

In FIGS. 1 through 3, both the first blocking section 3A and also the second blocking section 3B are in a release position. This is achieved in the present embodiment in that a locking device 17 is arranged between the actuating section 2 and the attachment section 4. Here, the locking device 17 comprises a projection 18 arranged in the attachment section 4. The projection 18 is embodied or formed as an extension, running radially outwards, of an inner cylinder 19. The inner cylinder 19 is thereby a component of the attachment section 4.

The locking device 17 furthermore has a recess 20 which is arranged in a cylindrical inner sleeve 21 of the first blocking section 3A. The locking device 17 also comprises a recess 22 which is arranged in a blocking ring 23 of the second blocking section 3B. The recess 22 is arranged on a radial inside of the blocking ring 23.

In the present setting of the dispensing device 1, both the first blocking section 3A and also the second blocking section 3B are located in a release position, as the projection 18 and the recesses 20, 22 are rotated to the same angle of rotation relative to a common rotational axis of the dispensing device 1. Here, the rotational axis coincides with the cylindrical axis of the dispensing device 1, which extends in an actuating direction.

If the consumer now applies a pressure to the actuating projection 16, the actuating section 2 moves with the first blocking section 3A and the second blocking section 3B towards the attachment section 4. The inner cylinder 19 is thereby slid into the attachment section 2. At the same time, the projection 18 penetrates the recesses 20, 22.

In order to ensure that this displacement operation occurs in the most uniform manner possible, a guide ring 24 is arranged between the attachment section 4 and the second blocking section 3B. The guide ring 24 has a gap 25, into which the projection 18 engages both in the neutral position and also during the actuating operation. The guide ring 24 also bears on a front face against the first blocking section 3A and the second blocking section 3B in an actuating direction. Overall, it is hereby ensured that the first blocking section 3A and the second blocking section 3B can be controllably displaced with respect to the attachment section 4. At the same time, the guide ring 24 also conceals the position of the recesses 20, 22 and thus acts as a visual cover.

By actuation of the actuating section 2, the volume of the pressure chamber interior 9 is now reduced, whereby the valve 14 closes and a pressure increase occurs. As a result of the pressure increase in the pressure chamber interior 9, an intermediate valve 26 opens. The intermediate valve 26 is thereby arranged in an interior component 27. The interior component 27 is radially arranged inside the actuating section 2. By the opening of the intermediate valve 26, a radial bore, which is not illustrated, of the interior component 27 is released. As a result of this, the fluid is guided up to the fluid outlet 28 between an inside of the actuating section 2 and an outside of the inner component 27.

Following the dispensing of the fluid through the fluid outlet 28, the actuating section 2 and the second blocking section 3B once again move into their neutral position. An underpressure is thereby produced again in the pressure chamber interior 9, whereby the valve 14 opens and new fluid can flow into the pressure chamber 7 in replacement.

Here, the dispensing device 1 also has a protective cap 29, which is to be removed by the consumer before an actuation.

In the present embodiment, the position of the recess 20 is recognizable for the consumer by a marking 30 arranged on a radial outside of the first blocking section 3A. The position of the recess 22 of the second blocking section 3B is also recognizable by a marking 31. The marking 31 is arranged on a radial outside of the second blocking section 3B.

The attachment section 4 also comprises a marking 32 arranged on a radial outside. The marking 32 thereby coincides with the circumferential angular position of the projection 18. However, in the present embodiment, the projection 18 is also arranged on an outside of the dispensing device in the unactuated state so that its position can be recognized by the consumer even without the marking 32.

In the present setting of the first blocking section 3A, the second blocking section 3B and the attachment section 4, the markings 30, 31 and 32 are arranged at the same angle of rotation relative to the actuating direction, or to a common rotational axis of the dispensing device 1. The user can thus bring the dispensing device 1 into an actuatable state by an alignment of the three markings 30, 31 and 32.

Furthermore, the dispensing device 1 has locking mechanisms between the actuating section 2, the blocking sections 3A, 3B and the attachment section 4. Thus, the sections 2, 3A, 3B and 4 are, for example, stably engaged so that a separation of the blocking sections 3A, 3B and of the actuating section 2 from the attachment section 4 is not possible without a very large application of force.

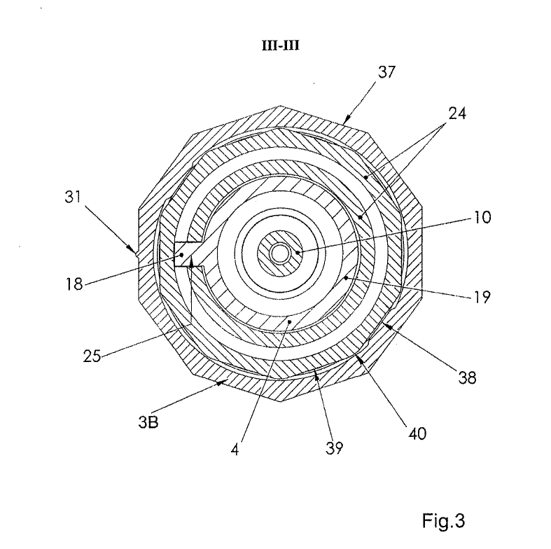

FIGS. 2 and 3 now show cross sections of the dispensing device 1 corresponding to the setting according to FIG. 1.

FIG. 2 shows a representation along the cross section II-II in a top-down view, or in the direction from the actuating section 2 in the direction towards the attachment section 4. In this illustration, it can be seen more clearly that the recesses 20 of the first blocking section 3A and the recess 22 of the second blocking section 3B are aligned with one another. The projection 18 is visible from above by its front-face. As can clearly be recognized, the locking device 17 is set here such that the projection 18 can engage in the recesses 20, 22. An actuation of the dispensing device 1 is thus possible.

In the present embodiment of FIGS. 1 through 9, the first blocking section 3A has, relative to the attachment section 4, one discrete release position and nine discrete blocking positions. This is achieved in that the inner cylinder 21 is embodied or formed as a decagon on its radial outside. The inner cylinder 21 thus has even surfaces 33 and edges 34 on its radial outside. The edges 34 are rounded and are each circumferentially located between two even surfaces 33 in parallel. For forming the ten setting positions, the second blocking section 3B has in the present example extensions 35 which are arranged on a radial inside of the second blocking section 3B. In this embodiment, two extensions 35 are arranged circumferentially on opposing sides of the second blocking section 3B. The first blocking section 3A can now, if it is rotated with respect to the second blocking section 3B, only engage in a position if an extension 35 is across from an even surface 33 in parallel. During the rotating operation between a first blocking section 3A and second blocking section 3B, an edge 34 passes over the extension 35 and is thereby preferably elastically deformed. This results in a small mechanical resistance which shows the user if the second blocking section 3B and the first blocking section 3A are not yet engaged in a position.

FIG. 3 now shows a further cross section of the dispensing device 1 corresponding to the setting according to FIG. 1 along the cross section III-III.

This cross section now directly transects the marking 31 of the second blocking section 3B. In the present embodiment of the dispensing device 1, the markings 30, 31 and 32 are embodied or formed as points projecting radially outwards. These points can, for example, also be felt by a consumer with limited vision.

As can be seen from FIG. 2, the first blocking section 3A is equipped with even outer surfaces 36 on its radial outside. At the same time, the second blocking section 3B is equipped with even outer surfaces 37 on its radial outside, as shown in FIG. 3. Thus, in the present embodiment, both the first blocking section 3A and also the second blocking section 3B are embodied or formed as a decagon on their radial outsides. This simplifies a rotation of the sections for the consumer, as a polygon is easier to grasp than a round ring. However, any other type of polygon is also conceivable here, wherein the number of edges should then correspond to the number of possible setting positions of a first blocking section 3A and second blocking section 3B, each relative to the attachment section.

According to FIGS. 1 through 9, only one marking 30, 31 and 32 is provided respectively on the radial outsides of the first blocking section 3A, the second blocking section 3B and the attachment section 4. Alternatively, it is also conceivable to arrange different markings on each of the even outer surfaces 36, 37 or also on possibly even outer surfaces of the attachment section 4. For example, a respective numbering from zero to nine is conceivable, precisely in the case of a decagon, whereby a combination lock, for example, would result.

In FIG. 3, the guide ring 24 can once again also be recognized in detail. From this, it is also evident how the projection 18 of the attachment section 4 engages in the gap 25. The attachment section 4 is thus non-rotatably connected to the guide ring 24. A relative movement in an axial direction between the guide ring 24 and the attachment section 4 is, however, still possible.

FIG. 3 now also shows how the discrete setting positions of the blocking ring 23 or of the second blocking section 3B can be achieved. For this purpose, there is a solution analogous to the discrete setting positions of the first blocking section 3A according to FIG. 2. The second blocking section 3B has extensions 38 on a radial inside. At the same time, the guide ring 24 comprises an even surface 39 and edges 40 on a radial outside. The extensions 38, the even surfaces 39 and the edges 40 now interact (analogously to the even surfaces 33, the edges 34 and the extensions 35) and define ten discrete setting positions of the second blocking section 3B relative to the guide ring 24 and thus also to the attachment section 4.

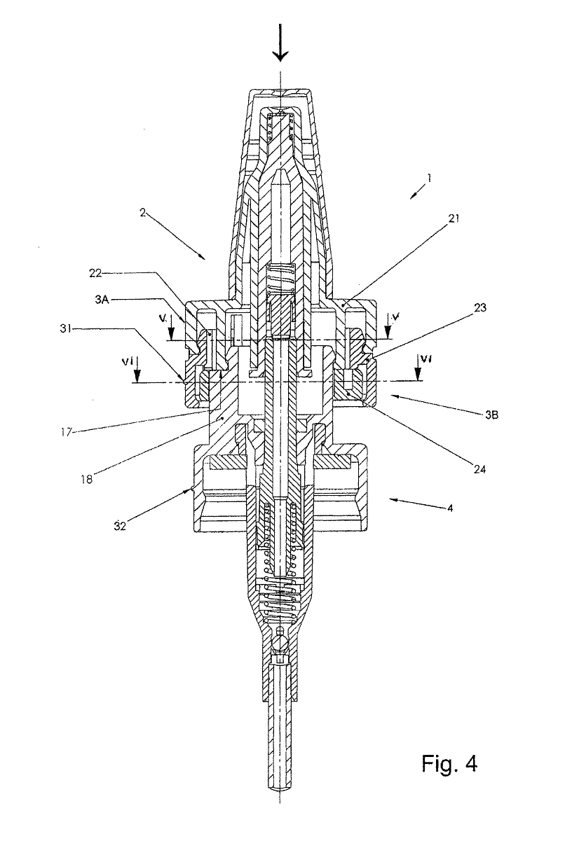

FIGS. 4 through 6 now show the same dispensing device according to FIGS. 1 through 3, wherein the discrete setting position of the actuating section 2 or the first blocking section 3A relative to the attachment section 4 was, however, modified.

The locking device 17 is blocked in this case, since the projection 18 bears with a front face against the inner sleeve 21 of the first blocking section 3A or of the actuating section 2. Accordingly, the marking 30 is not rotated to the same angle of rotation as the markings 31 and 32 and is not visible in FIGS. 4 through 6. Although the recess 22 of the second blocking section 3B is rotated to a release position, this alone is not sufficient to bring the dispensing device 1 into an actuatable state. Instead, it is necessary for both recesses 20, 22 of the locking device 17 to be aligned with the projection 18 in the rotation direction.

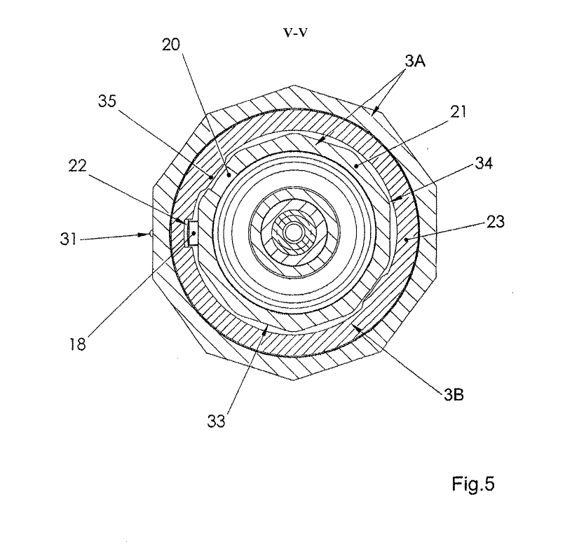

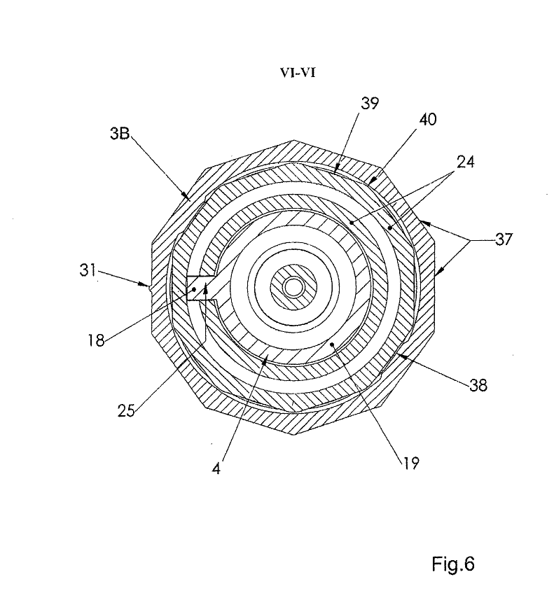

This can also be recognized once again in FIGS. 5 and 6, which again show two different cross sections along the lines V-V and VI-VI. In FIG. 5, it can now be recognized that the recess 20 was rotated by a clockwise rotation of the first blocking section 3B by one discrete rotation position with respect to the second blocking section 3B and the attachment section 4. The projection 18 therefore cannot engage in the recess 20 and instead strikes a front face of the inner sleeve 21 in the case of an actuation attempt. An actuation of the dispensing device 1 is thus not possible in this setting.

FIG. 6 now shows a further cross section of the dispensing device 1 corresponding to the setting according to FIG. 4 along the cross section VI-VI.

Here, it can once again be clearly recognized that the second blocking section 3B is still located in the same setting as in FIGS. 1 through 3. Accordingly, the marking 31 of the second blocking section 3B is aligned with the projection 18 in the rotation direction.

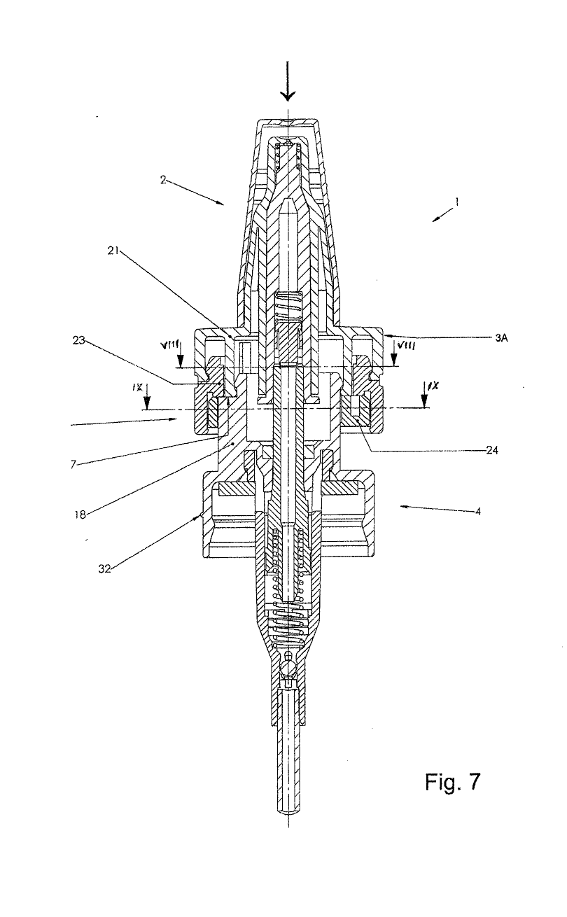

FIGS. 7 through 9 now show a further setting of the dispensing device 1. In this case, both the first blocking section 3A and also the second blocking section 3B are respectively located in a discrete blocking position relative to the attachment section 4. Accordingly, the projection 18 of the locking device bears with its front face against the blocking ring 23 and against the inner sleeve 21. Thus, a double blocking is present in a sense. However, as can be seen from FIGS. 4 through 6, it is already sufficient if either the second blocking section 3B or the first blocking section 3A is rotated into a blocking position relative to the attachment section 4. Therefore, neither the recesses 20, 22 nor the markings 30, 31 are visible in FIG. 7, as they are rotated with respect to the projection 18.

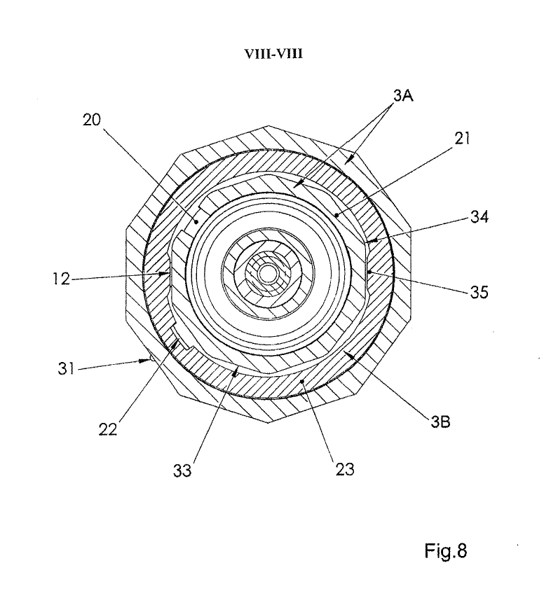

FIG. 8 now shows a section through FIG. 7 along the cross section VIII-VIII. Here, it is evident that the first blocking section 3A was rotated clockwise by one discrete position with respect to the projection 18 and therefore the attachment section 4. At the same time, the second blocking section 3B was rotated counter-clockwise by one discrete position with respect to the projection 18 and the attachment section 4. Accordingly, the front face of the projection 18 can hardly be recognized in this illustration, as it is concealed by the inner sleeve 21 and the blocking ring 23.

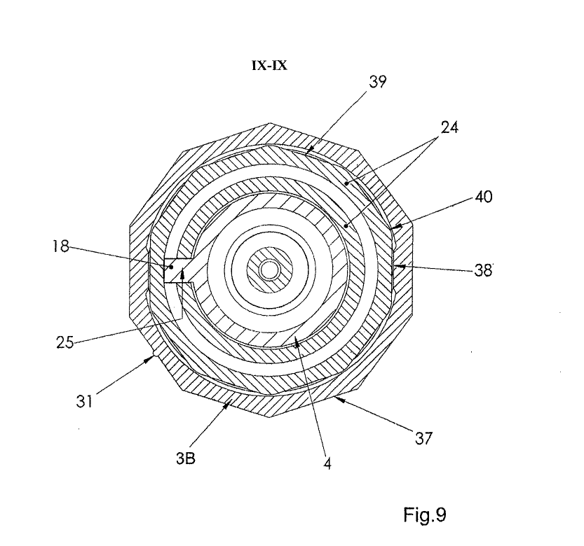

FIG. 9 now shows the cross section along the cross section IX-IX according to FIG. 7. From this, it can be recognized that the projection 18 is still located in the same position as also already in the previous eight Figures. At the same time, it is clearly recognizable that the second blocking section 3B was rotated counter-clockwise by one discrete position with respect to the projection 18 and the attachment section 4.

Overall, there thus results a dispensing device 1 according to the invention which has a plurality of blocked relative setting positions between a first blocking section 3A, a second blocking section 3B and an attachment section 4. At the same time, there is only one relative position of a first blocking section 3A, a second blocking section 3B and an attachment section 4 in which the dispensing device 1 can be actuated. This is shown precisely in FIGS. 1 through 3. By contrast, FIGS. 4 through 6 show a singly blocked setting position, and FIGS. 7 through 9 show a doubly blocked setting position of the three sections indicated.

In the illustrated embodiment, there are in total 100 relative setting positions of the three sections 3A, 3B and 4, of which 99 are either singly or doubly blocked. The dispensing device 1 therefore comprises an effective child safety device, and an unwanted actuation of the dispensing device 1, for example during the transport to the end consumer, is virtually excluded at the same time.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A dispensing device for fluids from a fluid container, comprising:
an attachment section;
a first blocking section;
a second blocking section;
an actuating section,
wherein a dispensing of the fluid results from actuation of the actuating section, and
wherein the actuation of the actuating section is blockable by a rotation of at least one of the first blocking section and the second blocking section with respect to the attachment section.

2. The dispensing device according to claim 1, wherein the first blocking section is non-rotatably connected to the actuating section.

3. The dispensing device according to claim 1, wherein, with regard to the attachment section, the first blocking section comprises at least one discrete release position and at least two discrete blocking positions.

4. The dispensing device according to claim 1, wherein, with regard to the attachment section, the second blocking section comprises has at least one discrete release position and at least two discrete blocking positions.

5. The dispensing device according to claim 1, wherein the second blocking section, with regard to an actuation direction, is arranged between the first blocking section and the attachment section and is rotatable relative to the first blocking section.

6. The dispensing device according to claim 1, wherein at least one marking each is arranged respectively on an outside of the first blocking section, the second blocking section and the attachment section.

7. The dispensing device according to claim 1, further comprising at least one locking device being arranged between the first blocking section, the second blocking section and the attachment section.

8. The dispensing device according to claim 7, wherein the at least one locking device comprises at least one recess and at least one projection.

9. The dispensing device according to claim 8, wherein the locking device is structured to block actuation of the actuating section, unless the at least one recess and the at least one projection are rotated to the same angle of rotation relative to a common rotational axis of the first blocking section, the second blocking section and the attachment section.

10. The dispensing device according to claim 8, wherein, in an unactuated state, the at least one projection is arranged on an outside of the dispensing device.

11. The dispensing device according to claim 8, wherein the at least one recess comprises a first recess in first blocking section and second recess in the second blocking section, and the attachment section comprises the at least one projection.

12. The dispensing device according to claim 1, wherein at least one of the first blocking section and the second blocking section comprises a blocking ring that is rotatably connected to the actuating section.

13. The dispensing device according to claim 1, further comprising a guide ring that is displaceable, with respect to the attachment section, in an actuating direction.

14. The dispensing device according to claim 13, wherein the guide ring is arranged in a non-rotatable manner with respect to the attachment section.

15. A method of actuating the actuating section of the dispensing device according to claim 1, comprising:
providing indicia on at least the first blocking section, the second blocking section and the attachment section;
aligning the indicia on the first blocking section, the second blocking section and the attachment section at a specified angular position around an axis of rotation for at least the first blocking section and the second blocking section; and
axially moving a part of the actuating section toward the attachment section.

16. A method of actuating a dispensing device that includes a first blocking section, a second blocking section and an attachment section that are rotatable about a common axis, and an actuating section that is axially movable along the common axis when at least the first blocking section and the second blocking section are aligned in an unblocking position, the method comprising:
providing indicia on at least the first blocking section and the second blocking section;
aligning the indicia on the first blocking section and the second blocking section at a specified angular position around the common axis at which the first blocking section and the second blocking section are aligned in the unblocking position;
pushing a part of the actuating section toward the attachment section.

17. The method according to claim 16, further comprising:
providing further indicia on the attachment section to identify the specified angular position for aligning the indicia.

18. The method according to claim 17, wherein at least the first blocking section and the second blocking section comprise polygonal outer peripheries comprising flat surfaces joined at edges.

19. The method according to claim 18, wherein the polygonal outer periphery of the first blocking section has M flat surfaces, where M is a number greater than 2, and the polygonal outer periphery of the second blocking section has N flat sides, where N is a number greater than 2, whereby the first blocking section and the second blocking section are rotatable into (M×N) total positions relative to the further indicia on the attachment section, of which only one of the M×N positions is the unblocking position.

20. The method according to claim 19, wherein the indicia on the first blocking section and the second blocking section include markings on one or more of the flat sides and the further indicia on the attachment section includes a further marking, and the markings and the further marking include at least one of numbers, letters and symbols so that by aligning the markings on the first blocking section and the second blocking section and the further marking on the attachment section according to a predetermined code or pattern identifying the unblocking position is achieved.
